(19) United States
(12) Patent Application Publication
(10) Pub. No.: US 2025/0363153 A1
(43) Pub. Date: Nov. 27, 2025

(54) COMPUTER-READABLE RECORDING MEDIUM, SEARCH PROCESSING METHOD, AND SEARCH PROCESSING DEVICE

(71) Applicant: Fujitsu Limited, Kawasaki-shi (JP)

(72) Inventor: KOTA ANADA, Kawasaki (JP)

(73) Assignee: Fujitsu Limited, Kawasaki-shi (JP)

(21) Appl. No.: 19/292,440

(22) Filed: Aug. 6, 2025

Related U.S. Application Data
(63) Continuation of application No. PCT/JP2023/045674, filed on Dec. 20, 2023.

(30) Foreign Application Priority Data
Feb. 17, 2023 (JP) 2023-023643

(51) Int. Cl. G06F 16/334; G06F 40/279; G06V 30/10

(52) U.S. Cl. CPC G06F 16/3344; G06F 40/279; G06V 30/10

(57) ABSTRACT

A non-transitory computer-readable recording medium has stored therein a program that causes a computer to execute a process. The process includes extracting a first character string included in image data from one or a plurality of pieces of data including the image data by character recognition processing, performing a search on the plurality of pieces of data using a keyword to specify, as a search result, a second character string included in the first character string based on similarity with the keyword in the search on the image data, and

displaying, in a case of displaying a search result in which one or more pieces of data including the second character string are indicated in a list, the image data included in the one or more pieces of data in a state where the second character string in the image data is identifiable.

### CROSS-REFERENCE TO RELATED APPLICATION

This application is a continuation of International Application No. PCT/JP2023/045674, filed on Dec. 20, 2023 which claims the benefit of priority of the prior Japanese Patent Application No. 2023-023643, filed on Feb. 17, 2023, the entire contents of which are incorporated herein by reference.

### FIELD

The embodiments discussed herein are related to a computer-readable recording medium, a search processing method, and a search processing device.

### BACKGROUND

As an information and communication technology (ICT) system becomes more complicated due to use of a plurality of clouds and the like, it is considered that it takes more time than ever to answer an inquiry from a user, the trouble investigation, and the like in IT service operations. Therefore, in order to improve the satisfaction level of the user for the IT service, improve the work efficiency, and reduce the cost, a solution for preparing, searching, and sharing of information utilizing artificial intelligence (AI) has been proposed.

As one of such solutions, there is a technique of facilitating document search by preparing and sharing a large number of dormant documents in a company. By adopting this technique, it is possible to quickly and accurately search for a target document from a huge amount of documents in a company, and it is possible to improve work efficiency and the like. In such document search, not only characters described as character information in a text or the like but also characters in an image attached to a document are set as targets to be searched, so that more accurate search can be performed.

Note that the following techniques exist as techniques of character string search for image data. For example, a technique has been proposed in which character recognition processing is performed on image data obtained by photoelectrically reading a reading target including a character string to recognize the character string included in the image data, search is performed on the recognized character string, and the character string to be searched and the character string of the search result are collated and evaluated.

Japanese Laid-open Patent Publication No. 2016-81445

However, in a case where character information is extracted from an image described in a document, character recognition is performed by inference using deep learning, unlike extraction of characters described as text. In the case of character recognition by inference of deep learning, there is a possibility that a character is erroneously recognized. In a case where a character is erroneously recognized, a word including the erroneously recognized character does not match a search word and thus is not displayed as a search result. Therefore, in the document search technique in the related art, there is a possibility that an intended document is not extracted, and it is difficult to improve search efficiency.

In addition, in the technique of collating and evaluating the search result with the character string to be searched for the character string recognized as an image, it is difficult to specify an actual character string in a document corresponding to the character string of the search result and it is difficult to improve the search efficiency.

### SUMMARY

According to an aspect of an embodiment, a non-transitory computer-readable recording medium has stored therein a program that causes a computer to execute a process. The process includes extracting a first character string included in image data from one or a plurality of pieces of data including the image data by character recognition processing. The process includes

performing a search on the plurality of pieces of data using a keyword to specify, as a search result, a second character string included in the first character string based on similarity with the keyword in the search on the image data. The process includes displaying, in a case of displaying a search result in which one or more pieces of data including the image data including the second character string are indicated in a list, the image data included in the one or more pieces of data in a state where the second character string in the image data included in the one or more pieces of data is identifiable.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a search processing device according to an embodiment;

FIG. 2 is a diagram illustrating an example of a search result display screen;

FIG. 3 is a diagram illustrating a specific example of search processing;

FIG. 4 is a diagram illustrating another specific example of search processing;

FIG. 5 is a flowchart of document data storage processing by a search processing device according to an embodiment;

FIG. 6 is a flowchart of search processing of a document that is entirely image data by a search processing device according to an embodiment; and

FIG. 7 is a hardware configuration diagram of a search processing device.

### DESCRIPTION OF EMBODIMENTS

Preferred embodiments of the present invention will be explained with reference to accompanying drawings. Note that the computer-readable recording medium, the search processing method, and the search processing device disclosed in the present application are not limited by the following embodiments.

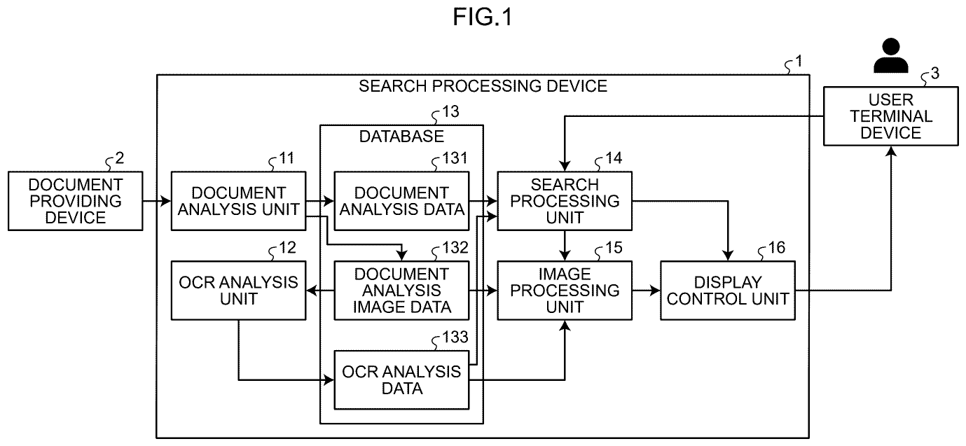

FIG. 1 is a block diagram of a search processing device according to an embodiment. A search processing device 1 according to the present embodiment is connected to a document providing device 2 and a user terminal device 3 via a network.

The document providing device 2 holds, for example, a large number of dormant documents in a company. The document providing device 2 may be a database.

The user terminal device 3 is a computer operated by a user who uses the search processing device 1 in order to perform document search. The user terminal device 3 includes a display device such as a monitor (not illustrated) and an input device such as a keyboard and a mouse. The user can send a search keyword and an execution instruction for search processing to the search processing device 1 using the input device of the user terminal device 3. In addition, the user can check the search result of the specified keyword by referring to a screen of the search result displayed on the display device of the user terminal device 3.

The search processing device 1 holds information regarding a document, executes a search using the keyword specified by the user, and displays the search result on the user terminal device 3. Details of the search processing device 1 will be described below. The search processing device 1 according to the present embodiment includes a document analysis unit 11, an optical character recognition (OCR) analysis unit 12, a database 13, a search processing unit 14, an image processing unit 15, and a display control unit 16.

The document analysis unit 11 acquires data of a plurality of documents from the document providing device 2. The document may have an image attached along with text, which is a character string described as character information, or the entire data may be image data. Then, the document analysis unit 11 executes document analysis on each document.

Specifically, the document analysis unit 11 acquires attribute information from data of the document. For example, the document analysis unit 11 acquires a document identifier (ID), a creation date and time, an author, and the like.

Furthermore, the document analysis unit 11 extracts text data and image data in the document. Furthermore, the document analysis unit 11 acquires an image ID of the extracted image data from the data of the document.

Then, the document analysis unit 11 stores the data of the text together with the attribute information of the document in the database 13 as document analysis data 131. In addition, the document analysis unit 11 stores the extracted image data and the image ID in the database 13 as document analysis image data 132 in association with a document ID of the document to which the image is attached.

The OCR analysis unit 12 acquires each piece of image data included in the document analysis image data 132 registered in the database 13. Then, the OCR analysis unit 12 executes OCR analysis on each piece of the acquired image data, and extracts a character included in each piece of image data as an inference result by OCR.

At this time, the OCR analysis unit 12 groups characters in the image data to generate a character group. The character group is a group in which a plurality of recognized characters is put together, and the OCR analysis unit 12 can generate a character group in units of one sentence, for example. In addition, the OCR analysis unit 12 may generate a character group in units of words or may generate a character group in units of paragraphs. The OCR analysis unit 12 acquires positional information of each character group. For example, the OCR analysis unit 12 sets a rectangular region surrounding the character group, and acquires the positional information in the image data of each of the vertex of one point of the rectangular region and the vertex at a position facing the vertex of the one point, as the positional information of the character group. That is, the region of the character group in the image data is defined by the positional information.

Then, the OCR analysis unit 12 assigns an OCR text ID as identification information to each character group. Then, in association with the OCR text ID, the OCR analysis unit 12 stores information of the character string included in the character group indicated by the OCR text ID, the positional information of the character group, and the image ID of the image data from which the character group is extracted, in the database 13 as OCR analysis data 133. Here, the character string refers to a plurality of arranged characters. Hereinafter, a character string corresponding to the entire character group is referred to as an “entire character string”. This entire character string corresponds to an example of the “first character string”.

The search processing unit 14 receives an input of a keyword used for search from the user terminal device 3 together with an execution instruction for document search. Then, the search processing unit 14 searches all the documents provided from the document providing device 2 using the keyword.

Here, the search of one document by the search processing unit 14 will be described in detail. The search processing unit 14 selects the data of the document one by one from the data of the document included in the document analysis data 131. Next, in a case where there is a text in the data of the selected document, the search processing unit 14 searches the text of the document using a keyword, and extracts a character string matching the keyword as a search result. Then, the search processing unit 14 holds the search result of the text together with the document ID.

Furthermore, in a case where an image is attached to the selected document, the search processing unit 14 acquires an image ID corresponding to the document ID of the document from the document analysis image data 132. In a case where a plurality of pieces of image data is included in the document, the search processing unit 14 acquires all the image IDs of all pieces of image data included in the document.

Next, the search processing unit 14 acquires the OCR text ID corresponding to the acquired image ID and the entire character string of the character group corresponding to the OCR text ID from the OCR analysis data 133 stored in the database 13. Then, the search processing unit 14 executes a search on the acquired entire character string on the basis of the similarity with the keyword, specifies a character string satisfying a predetermined condition in a descending order of the similarity degree with the keyword, and sets the character string as a character string searched using the keyword. Hereinafter, the character string extracted from the entire character string based on the keyword is referred to as a “partial character string”. Here, the partial character string is a part or the whole of the entire character string. Then, the character string specified from the partial character string becomes the character string searched using the keyword. The character string searched using the keyword corresponds to an example of a “second character string”.

For example, the search processing unit 14 calculates a score representing a similarity degree for each partial character string included in the entire character string. Then, the search processing unit 14 sets a partial character string having a score exceeding a predetermined threshold value as a character string searched using the keyword, and sets the character string as a search result of the document in the search processing using the keyword. The number of character strings searched using the keyword may be one or plural. In a case where there is no partial character string having a score exceeding the threshold value, the search processing unit 14 determines that there is no character string searched using the keyword.

More specifically, the search processing unit 14 calculates an editing distance between the partial character string and the keyword. Then, the search processing unit 14 sets a partial character string of which a value of the editing distance is closer than the threshold value in the partial character string, as the character string searched using the keyword which is the search result.

Here, in the present embodiment, the search processing unit 14 sets the partial character string of which the similarity degree exceeds the threshold value as the character string searched using the keyword, but the method of deciding the character string searched using the keyword may be another method. For example, the search processing unit 14 may set a predetermined number of partial character strings as the character strings searched using the keyword in a descending order of the similarity degree. In this case, the search processing unit 14 can use a value of about five to ten as the predetermined number.

Thereafter, the search processing unit 14 outputs the search result of the text and the search result of the image data in the document to the display control unit 16 together with the document ID. In addition, the search processing unit 14 outputs the OCR text ID of the entire character string including the character string searched using the keyword as the search result, to the image processing unit 15.

The image processing unit 15 receives an input of the OCR text ID of the character string searched using the keyword, from the search processing unit 14. Next, the image processing unit 15 acquires the image ID and the positional information of the character group corresponding to the acquired OCR text ID, from the OCR analysis data 133. Next, the image processing unit 15 acquires the image data and the document ID corresponding to the acquired image ID, from the document analysis image data 132.

Then, the image processing unit 15 processes the image data by displaying, in an emphasized manner, a region in the acquired image data indicated by the positional information of the character group including the character string searched using the keyword. In a case where there is a plurality of character groups including the character string searched using the keyword in the image data, the image processing unit 15 displays, in an emphasized manner, all the character groups in the image data in a similar procedure. Thereafter, the image processing unit 15 outputs the processed image data to the display control unit 16 together with the document ID.

The display control unit 16 receives an input of the document ID, and the search result of the text and the search result of the image data in the document, from the search processing unit 14. In addition, the display control unit 16 receives an input of the document ID and the processed image data from the image processing unit 15. Then, the display control unit 16 generates a search result display screen in which the search result in each document is displayed using the search result of the text, the search result of the image data, and the image data. Thereafter, the display control unit 16 transmits the search result display screen to the user terminal device 3, and causes the display device to display the search result display screen. As a result, the display control unit 16 provides the search result to the user.

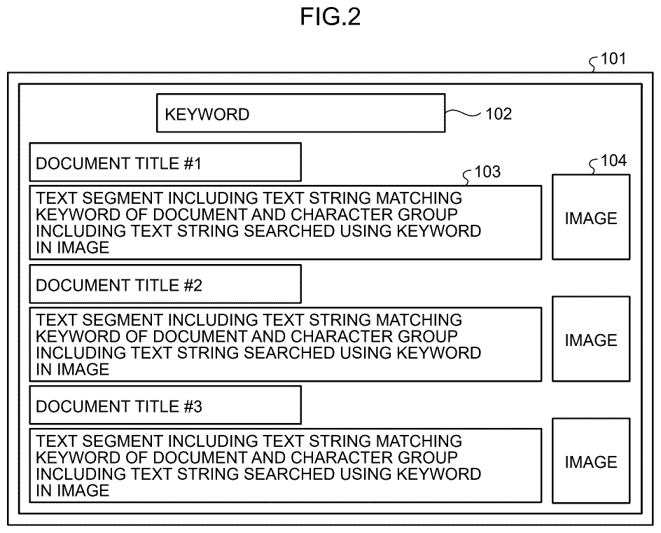

FIG. 2 is a diagram illustrating an example of the search result display screen. For example, the display control unit 16 generates a screen 101 as the search result display screen illustrated in FIG. 2. As illustrated in FIG. 2, the display control unit 16 displays the keyword used for the search, in a keyword field 102 of the screen 101.

Then, the display control unit 16 displays the search result in a search result field 103 of the screen 101 for each document. In a case of displaying the search result of the text, the display control unit 16 displays a text segment including a character string matching the keyword in the search result field 103, and displays the character string as the search result in an emphasized manner. Here, the text segment including the character string matching the keyword may be the entire text, or one text segment or a plurality of text segments including the character string matching the keyword. In addition, in a case of displaying the search result of the image data, the display control unit 16 displays the character group including the character string searched using the keyword, in the search result field 103. At this time, the display control unit 16 displays, in an emphasized manner, the character string searched using the keyword in the character group displayed in the search result field 103. In addition, the display control unit 16 may display another character group included in the image data side by side in the search result field 103. Furthermore, in a case where the sentence displayed in the search result field 103 is the sentence included in the image, the display control unit 16 displays the image in which the character group including the character string searched using the keyword is displayed in an emphasized manner, in an image field 104 of the screen 101.

Here, the screen 101 is a search result display screen, but can also be used as a keyword input screen. For example, the display control unit 16 causes the display device of the user terminal device 3 to display the screen 101 before the search on which the search result is not registered. Then, the search processing unit 14 may receive a search keyword by the user inputting the search keyword into the keyword field 102 by using the input device of the user terminal device 3.

Here, the display of the information on the search result display screen corresponds to an example of “displaying a search result that indicates, in a list, one or more pieces of data including image data including the second character string”. For example, on the screen 101 of FIG. 2, the image data of the image in which the character group including the character string searched using the keyword is displayed in an emphasized manner and which is displayed in the image field 104 corresponds to an example of “image data including the second character string”. The data indicated in the search result field 103 and the image field 104 corresponds to an example of “one or more pieces of data”. As described above, when displaying a search result that indicates, in a list, one or more pieces of data including the image data including the second character string, the display control unit 16 displays the image data included in one or more pieces of data in a state where the second character string in the image data included in the one or more pieces of data can be identified.

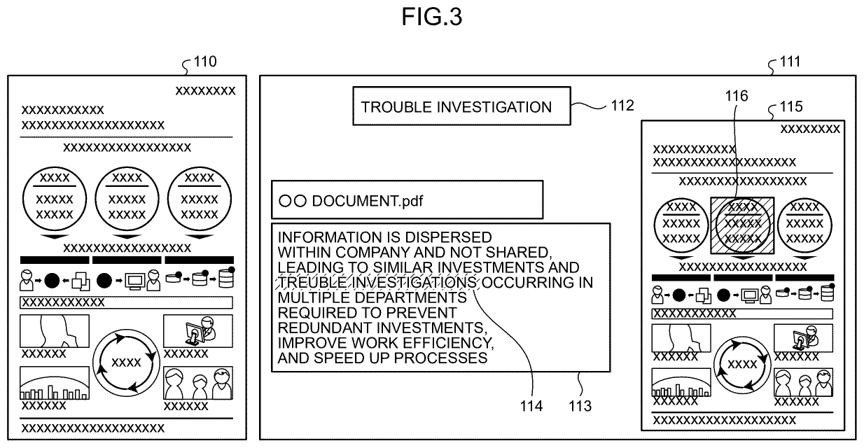

FIG. 3 is a diagram illustrating a specific example of search processing. A document 110 is a document to be searched. The document 110 is a digitized document created by scanning a flyer, and the entire document is image data. In addition, a screen 111 is a search result screen of the document 110. Here, as illustrated in a keyword field 112 of the screen 111, a case where “trouble investigation” is designated as the search keyword will be described.

Since the entire document 110 is image data, the search processing unit 14 acquires the entire character string of a plurality of character groups included in the entire document 110 from the OCR analysis data 133. Next, the search processing unit 14 performs the following search on each acquired entire character string with “trouble investigation” as a keyword. The search processing unit 14 calculates an editing distance between “trouble investigation” and each partial character string included in the entire character string. Next, the search processing unit 14 specifies a partial character string of which the editing distance is closer than the predetermined threshold value in each partial character string, as the character string searched using the keyword. Here, the search processing unit 14 specifies one character string of “treuble investigation” included in the document 110 as the character string searched using the keyword. As a result, the search processing unit 14 specifies a character string 114 of “treuble investigation” indicated in a search result field 113 of the screen 111 as the character string searched using the keyword.

In addition, the image processing unit 15 acquires the image data of the document 110 from the document analysis image data 132. Next, the image processing unit 15 acquires the positional information of the character group including “treuble investigation” that is the character string searched using the keyword by the search processing unit 14, from the OCR analysis data 133. Then, the image processing unit 15 processes the image data by displaying, in an emphasized manner, the region indicated by the acquired positional information in the image data. As a result, the image processing unit 15 generates image data in which a region 116 including the character string detected using the keyword in the image is displayed in an emphasized manner, as illustrated in an image field 115 of the screen 111.

The display control unit 16 generates the screen 111 using the information acquired from the search processing unit 14 and the image processing unit 15. The screen 111 includes the search result field 113 in which the character string 114 corresponding to the character string searched using the keyword is displayed in an emphasized manner. In addition, the screen 111 includes the image field 115 indicating image data in which the region 116 corresponding to the character group including the character string detected using the keyword in the image is displayed in an emphasized manner. Then, the display control unit 16 causes the display unit of the user terminal device 3 to display the screen 111 that is the search result display screen. By referring to the screen 111, for example, even when the OCR result is incorrect such as misrecognizing “trouble” as “treuble”, the user can determine whether or not the character string extracted by the search is correct by referring to the OCR result and the actual image.

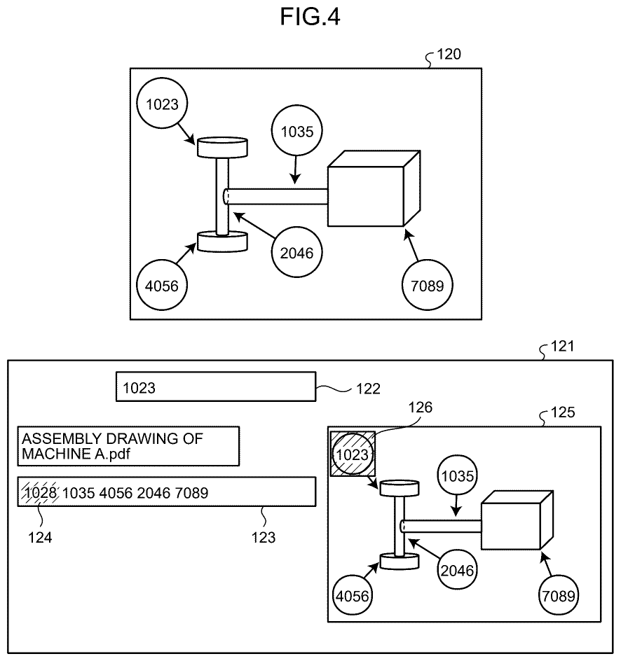

FIG. 4 is a diagram illustrating another specific example of the search processing. A document 120 is a document to be searched. The document 120 is a diagram of a machine that displays components used in the machine in association with numbers, and the entire document is image data. In addition, a screen 121 is a search result screen of the document 120. Here, as illustrated in a keyword field 122 of the screen 121, a case where “1023”, which is a number assigned to a component, is designated as the search keyword will be described.

Since the entire document 120 is image data, the search processing unit 14 acquires the entire character string of a plurality of character groups included in the entire document 120 from the OCR analysis data 133. Next, the search processing unit 14 performs the following search on each acquired entire character string with “1023” as a keyword. The search processing unit 14 calculates an editing distance between “1023” and each partial character string included in the entire character string. Then, the search processing unit 14 specifies a partial character string of which the editing distance is closer than the predetermined threshold value among the partial character strings included in the entire character string, as the character string searched using the keyword. Here, the search processing unit 14 specifies one character string of “1028” included in the document 120 as the character string searched using the keyword. As a result, the search processing unit 14 specifies a character string 124 of “1028” indicated in a search result field 123 of the screen 121 as the character string searched using the keyword.

In addition, the image processing unit 15 acquires the image data of the document 120 from the document analysis image data 132. Next, the image processing unit 15 acquires the positional information of the character group including “1028” that is the character string searched using the keyword by the search processing unit 14, from the OCR analysis data 133. Then, the image processing unit 15 processes the image data by displaying, in an emphasized manner, the region indicated by the acquired positional information in the image data. As a result, the image processing unit 15 generates image data in which a region 126 including the character string detected using the keyword in the image is displayed in an emphasized manner, as illustrated in an image field 125 of the screen 121.

The display control unit 16 generates the screen 121 using the information acquired from the search processing unit 14 and the image processing unit 15. The screen 121 includes the search result field 123 in which the character string 124 corresponding to the character string searched using the keyword is displayed in an emphasized manner. In addition, the screen 121 includes the image field 125 indicating image data in which the region 126 corresponding to the character group including the character string detected using the keyword in the image is displayed in an emphasized manner. Then, the display control unit 16 causes the display unit of the user terminal device 3 to display the screen 121 that is the search result display screen. By referring to the screen 121, for example, even when the OCR result is incorrect such as misrecognizing “1023” as “1028”, the user can determine whether or not the character string extracted by the search is correct by referring to the OCR result and the actual image.

Here, in the specific example using FIGS. 3 and 4, the search processing in a case where the entire document is image data has been described. However, the target to be searched may be a document including text and image data, or may be a document including text but not including image data. In the case of a document including text and image data, the display control unit 16 generates a search result display screen in which a search result of the text and a search result of the image data are combined. In addition, in the case of a document including text but not including image data, the display control unit 16 generates a search result display screen in which a search result of the text is displayed.

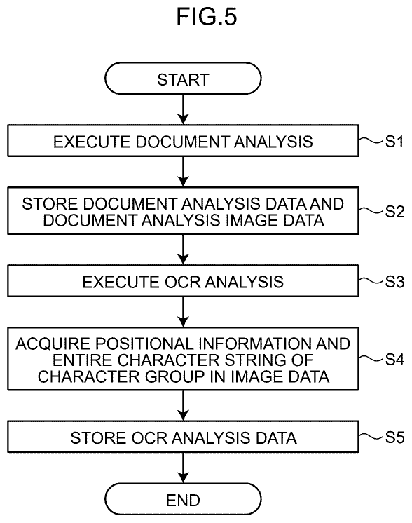

FIG. 5 is a flowchart of the document data storage processing by the search processing device according to the embodiment. Next, a flow of the document data storage processing by the search processing device 1 according to the embodiment will be described with reference to FIG. 5.

The document analysis unit 11 acquires data of a plurality of documents from the document providing device 2. Then, the document analysis unit 11 executes document analysis on each document (Step S1).

Furthermore, the document analysis unit 11 extracts image data and data of text as the character string described as the character information in the document. Furthermore, the document analysis unit 11 acquires an image ID of the extracted image data from the data of the document. Then, the document analysis unit 11 stores the data of the text together with the attribute information of the document in the database 13 as the document analysis data 131. In addition, the document analysis unit 11 stores the extracted image data and the image ID in the database 13 as the document analysis image data 132 in association with the document ID of the document to which the image is attached (Step S2).

The OCR analysis unit 12 acquires each piece of image data included in the document analysis image data 132 registered in the database 13. Then, the OCR analysis unit 12 executes OCR analysis on each piece of the acquired image data, and extracts a character included in each piece of image data as the inference result by OCR (Step S3).

Next, the OCR analysis unit 12 groups characters in the image data to generate a character group, and acquires the entire character string for each character group. In addition, the OCR analysis unit 12 acquires positional information of each character group (Step S4).

Next, the OCR analysis unit 12 assigns an OCR text ID as identification information to each character group. Then, in association with the OCR text ID, the OCR analysis unit 12 stores the entire character string included in the character group, the positional information of the character group, and the image ID of the image data from which the character group is extracted, in the database 13 as the OCR analysis data 133 (Step S5).

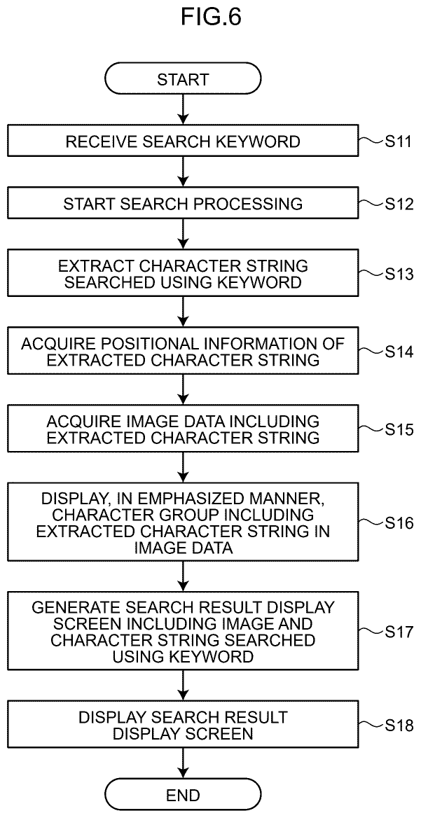

FIG. 6 is a flowchart of the search processing of the document that is entirely image data by the search processing device according to the embodiment. Next, with reference to FIG. 6, a flow of the search processing on the document that is entirely image data by the search processing device 1 according to the embodiment will be described.

The search processing unit 14 receives a keyword used for search from the user terminal device 3 together with an execution instruction for document search (Step S11).

Next, the search processing unit 14 starts search processing using the keyword with respect to all the documents provided from the document providing device 2 (Step S12).

The search processing unit 14 acquires the image ID of the image data corresponding to the document to be searched, from the document analysis image data 132. Next, the search processing unit 14 acquires the information of the OCR text ID corresponding to the acquired image ID and the entire character string of the character group indicated by the OCR text ID from the OCR analysis data 133 stored in the database 13. Then, the search processing unit 14 calculates a score representing a similarity degree with the keyword for each partial character string included in the acquired entire character string. Then, the search processing unit 14 extracts the character string obtained by searching the partial character string having a score exceeding a predetermined threshold value, using the keyword (Step S13).

The image processing unit 15 receives an input of the OCR text ID of the character string searched using the keyword, from the search processing unit 14. Next, the image processing unit 15 acquires the image ID and the positional information of the character group corresponding to the acquired OCR text ID, from the OCR analysis data 133 (Step S14).

Next, the image processing unit 15 acquires the image data and the document ID corresponding to the acquired image ID, from the document analysis image data 132 (Step S15).

Then, the image processing unit 15 uses the positional information of the character group including the character string searched using the keyword to process the image data by displaying, in an emphasized manner, the character group including the character string searched using the keyword (Step S16).

The display control unit 16 generates the search result display screen including the character string searched using the keyword extracted by the search processing unit 14 and the image data processed by the image processing unit 15 (Step S17).

Then, the display control unit 16 transmits the search result display screen to the user terminal device 3, and causes the display device to display the search result display screen (Step S18).

### Hardware

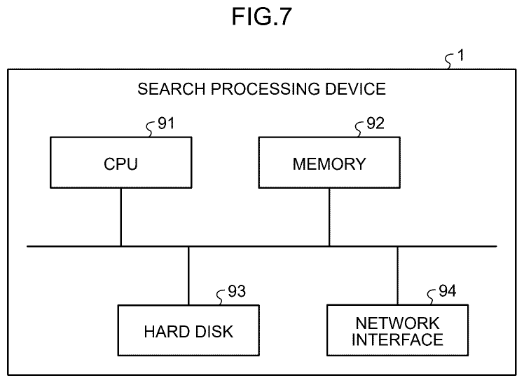

FIG. 7 is a hardware configuration diagram of the search processing device. Next, a hardware configuration example of the search processing device 1 will be described with reference to FIG. 7.

The search processing device 1 includes, for example, a CPU 91, a memory 92, a hard disk 93, and a network interface 94. The CPU 91 is connected to the memory 92, the hard disk 93, and the network interface 94 via a bus.

The network interface 94 is a communication interface between the search processing device 1 and an external device. For example, the network interface 94 relays communication between the CPU 91 and the document providing device 2 or the user terminal device 3.

The hard disk 93 is an auxiliary storage device. The hard disk 93 realizes the function of the database 13 illustrated in FIG. 1. In addition, the hard disk 93 stores various programs including programs including programs for realizing the respective functions of the document analysis unit 11, the OCR analysis unit 12, the search processing unit 14, the image processing unit 15, and the display control unit 16 illustrated in FIG. 1.

The memory 92 is a main storage device. The memory 92 is, for example, a dynamic random access memory (DRAM).

The CPU 91 reads various programs stored in the hard disk 93, develops the programs in the memory 92, and executes the programs. As a result, the CPU 91 realizes the function of each of the document analysis unit 11, the OCR analysis unit 12, the search processing unit 14, the image processing unit 15, and the display control unit 16.

In addition, the search processing device 1 can realize the functions similar to those of the above-described embodiment by reading the program from a recording medium using a medium reading device and executing the read program. Note that the program here is not limited to being executed by the search processing device 1. For example, the present invention can be similarly applied to a case where another computer or server executes a program or a case where the computer and the server execute a program in cooperation.

This program can be distributed via a network such as the Internet. In addition, this program can be executed by being recorded on a computer-readable recording medium such as a hard disk, a flexible disk (FD), a CD-ROM, a magneto-optical disk (MO), or a digital versatile disc (DVD), and being read from the recording medium by the computer.

In one aspect, the present invention can improve search efficiency.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
extracting a first character string included in image data from one or a plurality of pieces of data including the image data by character recognition processing;
performing a search on the plurality of pieces of data using a keyword to specify, as a search result, a second character string included in the first character string based on similarity with the keyword in the search on the image data; and
displaying, in a case of displaying a search result in which one or more pieces of data including the image data including the second character string are indicated in a list, the image data included in the one or more pieces of data in a state where the second character string in the image data included in the one or more pieces of data is identifiable.

2. The non-transitory computer-readable recording medium according to claim 1,
wherein the specifying of the second character string includes processing of calculating an editing distance between the keyword and each partial character string included in the first character string as the similarity with the keyword and setting the partial character string of which the editing distance is shorter than a threshold value as the second character string.

3. The non-transitory computer-readable recording medium according to claim 1, the process further includes:
acquiring positional information indicating a region including the second character string; and
generating, as the image in which the second character string in the image data included in the one or more pieces of data is displayed to be identifiable, a display image in which the region indicated by the positional information in the image data included in the one or more pieces of data is displayed in an emphasized manner,
wherein the processing of displaying the image data included in the one or more pieces of data together with the search result includes processing of displaying the display image together with the search result including the second character string.

4. A search processing method comprising:
extracting a first character string included in image data from one or a plurality of pieces of data including the image data by character recognition processing;
performing a search on the plurality of pieces of data using a keyword to specify, as a search result, a second character string included in the first character string based on similarity with the keyword in the search on the image data; and
displaying, in a case of displaying a search result in which one or more pieces of data including the image data including the second character string are indicated in a list, the image data included in the one or more pieces of data in a state where the second character string in the image data included in the one or more pieces of data is identifiable, by processing circuitry.

5. The search processing method according to claim 4,
wherein the specifying of the second character string includes processing of calculating an editing distance between the keyword and each partial character string included in the first character string as the similarity with the keyword and setting the partial character string of which the editing distance is shorter than a threshold value as the second character string.

6. The search processing method according to claim 4, including:
acquiring positional information indicating a region including the second character string; and
generating, as the image in which the second character string in the image data included in the one or more pieces of data is displayed to be identifiable, a display image in which the region indicated by the positional information in the image data included in the one or more pieces of data is displayed in an emphasized manner,
wherein the processing of displaying the image data included in the one or more pieces of data together with the search result includes processing of displaying the display image together with the search result including the second character string.

7. A search processing device comprising:
processing circuitry configured to:
extract a first character string included in image data from one or a plurality of pieces of data including the image data by character recognition processing;
perform a search on the plurality of pieces of data using a keyword to specify, as a search result, a second character string included in the first character string based on similarity with the keyword in the search on the image data; and
display, in a case of displaying a search result in which one or more pieces of data including the image data including the second character string are indicated in a list, the image data included in the one or more pieces of data in a state where the second character string in the image data included in the one or more pieces of data is identifiable.

8. The search processing device according to claim 7,
wherein the processing circuitry is further configured to calculate an editing distance between the keyword and each partial character string included in the first character string as the similarity with the keyword and set the partial character string of which the editing distance is shorter than a threshold value as the second character string.

9. The search processing device according to claim 7,
wherein the processing circuitry is further configured to:
acquire positional information indicating a region including the second character string;
generate, as the image in which the second character string in the image data included in the one or more pieces of data is displayed to be identifiable, a display image in which the region indicated by the positional information in the image data included in the one or more pieces of data is displayed in an emphasized manner, and
display the display image together with the search result including the second character string.
